(19) United States
(12) Patent Application Publication
(10) Pub. No.: US 2025/0074392 A1
(43) Pub. Date: Mar. 6, 2025

(54) DYNAMIC ACCELERATION LIMITING SYSTEM FOR ELECTRIFIED VEHICLES

(71) Applicant: GM GLOBAL TECHNOLOGY OPERATIONS LLC, Detroit, MI (US)

(72) Inventors: Cody W. BULKLEY, Milford, MI (US); Stefan M. FRICK, West Bloomfield Township, MI (US); Matthew G. BUSH, West Bloomfield, MI (US); Brandon Michael SMITSKY, Royal Oak, MI (US); Jason KOHLER, White Lake, MI (US)

(21) Appl. No.: 18/461,234

(22) Filed: Sep. 5, 2023

(51) Int. Cl. B60W 20/13; B60L 58/12; B60W 10/06; B60W 10/08

(52) U.S. Cl. CPC B60W 20/13; B60L 58/12; B60W 10/06; B60W 10/08; B60W 2510/244; B60W 2520/105; B60W 2710/083

(57) ABSTRACT

An acceleration control system for a vehicle includes a battery pack, an electric machine and an inverter configured to output power from the battery pack to the electric machine. An accelerator module is configured to generate an acceleration request. A selector is configured to selectively enable a dynamic acceleration limiting mode. A dynamic acceleration limiting module is configured to identify, when the dynamic acceleration limiting mode is enabled, a qualified acceleration event in response to the accelerator request greater than an acceleration threshold and to output a dynamic acceleration limit for the electric machine to the inverter during the qualified acceleration event.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for dynamically limiting acceleration of an electric machine of an electrified vehicle.

Electric vehicles (EVs) include battery electric vehicles (BEVs), hybrid vehicles, and/or fuel cell vehicles. EVs include one or more electric machines supplied by power stored in a battery system including one or more battery cells, modules and/or packs. The one or more electric machines operate as a motor to propel the vehicle and as a generator during regeneration. Hybrid vehicles include one or more electric machines and an internal combustion engine that propel the vehicle. The EVs include a control module configured to control a power inverter to control charging and/or discharging of the battery system during charging, regeneration, and/or driving.

EVs such as hybrids and battery EVs have finite battery capacity and are subject to power and/or thermal constraints during use. Some EVs do not limit torque/power output and allow full utilization of the available electric power. When operating EVs in a performance mode (e.g., sport or track mode), allowing unlimited torque/power provides increased acceleration for a limited period. The unlimited torque/power approach can lead to vehicle performance issues such as power fade due to SOC consumption and/or thermal constraints, reduced capacity of the battery pack, inconsistent power delivery, etc. In other words, vehicle performance during a first lap is very high but vehicle performance fades rapidly (such as during subsequent laps).

### SUMMARY

An acceleration control system for a vehicle includes a battery pack, an electric machine and an inverter configured to output power from the battery pack to the electric machine. An accelerator module is configured to generate an acceleration request. A selector is configured to selectively enable a dynamic acceleration limiting mode. A dynamic acceleration limiting module is configured to identify, when the dynamic acceleration limiting mode is enabled, a qualified acceleration event in response to the accelerator request greater than an acceleration threshold and to output a dynamic acceleration limit for the electric machine to the inverter during the qualified acceleration event.

In other features, the accelerator module comprises an acceleration pedal and the acceleration threshold corresponds to a pedal position. The acceleration request corresponds to at least one of power request and a torque request. At least one of the selector enables selection of a performance mode of the vehicle and the dynamic acceleration limiting mode is enabled in response to the performance mode being active, and the selector enables dynamic acceleration limiting independently of selection of a performance mode of the vehicle.

In other features, the vehicle comprises a hybrid vehicle, and the dynamic acceleration limit varies as a function of time during the qualified acceleration event. The dynamic acceleration limit monotonically decreases as a function of time after reaching a peak value during the qualified acceleration event. The dynamic acceleration limiting module decreases the dynamic acceleration limit to a negative value during the qualified acceleration event.

In other features, a battery monitoring module configured to determine a state of charge of the battery pack. The dynamic acceleration limiting module is configured to receive the state of charge of the battery pack and to calculate consumed state of charge during the qualified acceleration event. The dynamic acceleration limiting module is configured to adjust the dynamic acceleration limit in response to the consumed state of charge.

In other features, the dynamic acceleration limiting module is configured to adjust the dynamic acceleration limit in response to vehicle speed. A battery monitoring module is configured to determine a state of charge of the battery pack. The dynamic acceleration limiting module is configured to receive the state of charge of the battery pack and to calculate consumed state of charge during the qualified acceleration event, and adjust the dynamic acceleration limit in response to the consumed state of charge and vehicle speed.

In other features, the vehicle comprises a battery electric vehicle. The dynamic acceleration limiting module is configured to disable the dynamic acceleration limiting mode after the qualified acceleration event until a change in vehicle speed is greater than a predetermined speed change threshold. The change in vehicle speed is based on a difference between a maximum vehicle speed during the qualified acceleration event and a current vehicle speed.

A method for controlling acceleration of an electric machine of a vehicle includes determining whether a dynamic acceleration limiting mode of the vehicle is active; when the dynamic acceleration limiting mode is active, selectively identifying a qualified acceleration event by comparing an acceleration request to a predetermined threshold; and when the dynamic acceleration limiting mode is active, setting an acceleration limit of the electric machine to a dynamic acceleration limit during the qualified acceleration event.

In other features, the method includes enabling selection of a performance mode of the vehicle, wherein the dynamic acceleration limiting mode is active in response to the performance mode being selected, and enabling the dynamic acceleration limiting mode independently of selection of a performance mode of the vehicle. The vehicle comprises one of a hybrid vehicle and a battery electric vehicle.

In other features, the method includes varying the dynamic acceleration limit as a function of time during the qualified acceleration event, and monotonically decreasing the dynamic acceleration limit as a function of time after reaching a peak value during the qualified acceleration event.

In other features, the method includes decreasing the dynamic acceleration limit to a negative value during the qualified acceleration event. The method includes calculating a state of charge of a battery pack; calculating consumed state of charge during the qualified acceleration event; and adjusting the dynamic acceleration limit in response to the consumed state of charge and vehicle speed.

An acceleration control system for a hybrid vehicle includes a powertrain including an internal combustion engine and a transmission propelling at least one wheel of the hybrid vehicle, a battery pack, and a battery monitoring module configured to determine a state of charge of the battery pack. An electric machine propels at least one wheel of the hybrid vehicle. An inverter is configured to output power from the battery pack to the electric machine. A selector is configured to selectively activate a dynamic acceleration limiting mode. A dynamic acceleration limiting module is configured to identify, when the dynamic acceleration limiting mode is active, a qualified acceleration event in response to a position of an accelerator pedal and to determine a dynamic acceleration limit for the electric machine during the qualified acceleration event. The dynamic acceleration limit varies as a function of time during the qualified acceleration event. The dynamic acceleration limiting module is configured to receive the state of charge of the battery pack and to calculate consumed state of charge during the qualified acceleration event. The dynamic acceleration limiting module is configured to adjust the dynamic acceleration limit in response to the consumed state of charge and vehicle speed.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a functional block diagram of an example of a hybrid vehicle including an internal combustion engine, an electric machine, and a hybrid control module including a dynamic acceleration limiting module according to the present disclosure;

FIG. 1B is a functional block diagram of an example of a battery electric vehicle including an electric machine and an EV control module including a dynamic acceleration limiting module according to the present disclosure;

FIG. 2 is a functional block diagram of an example of an acceleration control system including the dynamic acceleration limiting module according to the present disclosure;

FIG. 3 is a functional block diagram of an example of the dynamic acceleration limiting module according to the present disclosure;

FIG. 4 is a graph illustrating an example of secondary axle torque as a function of time for a hybrid vehicle during a qualified acceleration event according to the present disclosure;

FIG. 5 is a graph illustrating an example of state of charge as a function of time for a hybrid vehicle during a qualified acceleration event according to the present disclosure;

FIG. 6 is a graph illustrating an example of lap times of hybrid vehicles using unlimited torque and a static torque limit as compared to a dynamic torque limit according to the present disclosure;

FIG. 7 is a flowchart of an example of a method for performing dynamic acceleration limiting during qualified acceleration events according to the present disclosure; and

FIG. 8 is a flowchart of an example of a method for preventing reactivation of a dynamic acceleration limit under certain conditions according to the present disclosure.

In the drawings, reference numbers may be reused to identify similar and/or identical elements.

### DETAILED DESCRIPTION

An acceleration control system according to the present disclosure for an EV such as a hybrid or battery EV sets a dynamic acceleration limit in response to some types of acceleration events (e.g., qualified acceleration events). In some examples, the qualified acceleration events occur when a dynamic acceleration limit is enabled and an acceleration request that is greater than a threshold occurs (e.g., accelerator pedal position greater than a predetermined threshold). For example, the qualified acceleration events may occur on corner exits when the vehicle is used on a track (or during non-track driving as well). The dynamic acceleration limiting system sets a dynamic acceleration limit during the qualified acceleration events to provide more consistent performance (e.g., lap times) while extending battery usage.

The dynamic acceleration limiting system controls acceleration (e.g., torque/power and energy usage) in acceleration zones (for example, after a corner exit) and/or at lower vehicle speeds (e.g., where the additional acceleration provided by the electric machines(s) have the most impact). The amount of energy that is expended during an acceleration event varies with vehicle speed. Using energy in these locations has the most significant effect on lap time per unit of energy consumed. In some examples, the amount of energy to expend during each qualified acceleration event is also based on a state of charge (SOC) of the battery pack and/or thermal constraints of the battery pack and/or electric machine. The consideration of SOC and thermal constraints allows the SOC/capacity to last for a greater number of laps or acceleration events and helps to soften the transition into operating modes with reduced electric capability.

In some examples, the electric machine is operated as a generator to regenerate power (e.g., during a later portion of the qualified acceleration event) and return power back to the battery pack (e.g., at higher vehicle speeds and/or near the end of acceleration zones). Regeneration that occurs during later portions of the acceleration event (e.g., closer to a braking zone) will have minimal effect on the lap time. As can be appreciated, energy recovered during regeneration during one qualified acceleration event can be used for subsequent qualified acceleration events on subsequent corner exits.

For some hybrid applications, the dynamic acceleration limit applied during qualified acceleration events maintains a predetermined minimum SOC level so that energy is available for important control systems features (e.g., yaw error control, push to pass, or other vehicle functions). For example, the dynamic acceleration limit may be decreased to zero or a negative value in response to the SOC falling below the predetermined minimum SOC during the qualified acceleration event. For example, the dynamic acceleration limit may be decreased to zero or a negative value in response to a temperature of the battery pack and/or electric machine exceeding predetermined temperatures.

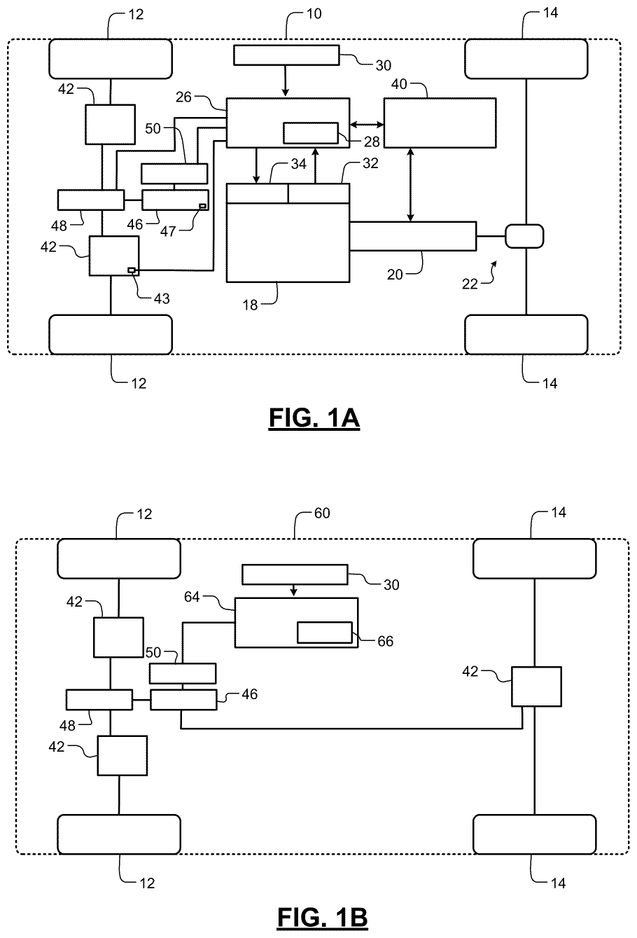

Referring now to FIG. 1A, a hybrid vehicle 10 includes front wheels 12 and rear wheels 14. In this example, the hybrid vehicle 10 includes an internal combustion engine (ICE) 18 and a transmission 20 supplying propulsion power via driveline components 22 to the rear wheels 14. A hybrid control module 16 includes a dynamic acceleration limiting module (DALM) 28 that controls acceleration (e.g., torque output) of the ICE 18 and/or the electric machine(s) 42 (acting as a motor) in response to driver inputs, vehicle speed, and/or other information. The dynamic acceleration limiting module 28 limits acceleration (e.g., torque/power) provided by the electric machine(s) 42 during qualified acceleration events to a dynamic acceleration limit as will be described further below.

The hybrid control module 26 receives data from sensors 32 (e.g., speed, temperature, oxygen, etc.) and uses the data to control actuators 34 that adjust operation of the ICE 18. The hybrid control module 26 may communicate with a transmission control module 40 that controls operation of the transmission 20. In some examples, temperature sensors 43 and/or 47 monitor temperatures of the electric machine(s) 42 and/or the battery pack 46, respectively. In some examples, temperature may also be used to end the qualified acceleration event (e.g., when one or both temperatures are greater than a predetermined temperature thresholds).

The front wheels 12 are propelled by electric machine(s) 42. The hybrid control module 26 determines the amount of acceleration to be delivered by the electric machine(s) 42 and/or the ICE 18. The hybrid control module 26 causes a battery pack 46 to supply power via a power inverter 48 to the electric machine(s) 42 to vary acceleration (e.g., torque/power output) provided by the electric machine(s) 42. A battery management module (BMM) 50 monitors the battery pack 46 using one or more sensors and calculates a state of the charge (SOC) of the battery pack 46 as will be described further below. While a specific hybrid architecture is shown, the dynamic acceleration limiting module can be used to dynamically limit acceleration for other hybrid architectures.

Referring now to FIG. 1B, an EV 60 includes an EV control module 64 including a dynamic acceleration limiting module 66. While a specific EV architecture is shown, the electric machine(s) and their location(s) can be varied for a given application. As can be appreciated, the EV does not include an internal combustion engine and may include additional or fewer electric machines (e.g., a rear motor) and/or a different configuration. While a specific EV architecture is shown, the dynamic acceleration limiting module can be used to dynamically limit torque for other EV architectures.

Referring now to FIG. 2, an energy control system for an electric vehicle is shown. A battery management module 210 monitors operation of a battery module/pack 212. One or more sensors 214 (such as current, voltage, temperature, and/or other types of sensors) measure one or more operating parameters of the battery module/pack 212. The battery management module 210 includes an SOC calculating module (SCM) 216 configured to calculate a state of charge (SOC) of the battery module/pack 212 in response to the one or more operating parameters. Typically, the SOC is calculated in response to temperature, voltage, current, and/or other parameters of the battery module/pack 212.

A dynamic acceleration limiting module 218 is configured to dynamically limit acceleration provided by the electric machine during qualified acceleration events in response to the SOC, driver mode, vehicle speed, temperature, and/or other parameters described below. In some examples, the dynamic acceleration limit controls torque, power, and/or other parameters related to torque and/or power.

Examples of driver input devices 220 include an acceleration module 222 generating an acceleration request. For example, the accelerator module 222 may include an acceleration pedal. In other examples, the acceleration request can be generated by another device and/or controller (e.g., an autonomous controller in an autonomous vehicle without an acceleration pedal). In some examples, a selector 224 comprises a mode selector to select a drive mode (e.g., a standard mode, an efficiency mode, a sport mode, a rain mode, a track mode, etc.) and some of the drive modes (such as the track and sport modes) enable the dynamic acceleration limit. In other examples, the selector 224 allows the driver to select dynamic acceleration limit independent of the selected drive mode.

The accelerator module 222 outputs an acceleration request (e.g., a pedal position). The selector 224 outputs a selected drive mode. The dynamic acceleration limiting module 218 receives the acceleration request and the selected drive mode. If the selected drive mode includes dynamic acceleration limiting by default (e.g., track or sport mode) or the selected drive mode is dynamic acceleration limiting, the dynamic acceleration limiting module 218 limits acceleration during the acceleration event to a dynamic acceleration limit. For example, the dynamic acceleration limiting module 218 limits acceleration (e.g., power/torque output) provided by the electric machine using the dynamic acceleration limit during the qualified acceleration event. The dynamic acceleration limiting module 218 outputs the torque/power command to a power inverter module 240 that controls output of an electric machine 244.

For example, a qualified acceleration event occurs when the driver depresses the accelerator pedal to a pedal position that is greater than a predetermined threshold (e.g., a wide open pedal (WOP) position such as 90% or greater). The acceleration event lasts as long as the accelerator pedal is at WOP (e.g., during a corner exit and straight section of a track). The dynamic acceleration limiting module 218 tracks SOC consumption (e.g., a decrease in SOC after the qualified acceleration event starts) and applies the dynamic acceleration limit to the electric machine as long as the qualified acceleration event continues. The dynamic acceleration limiting module 218 limits the total SOC consumption by the electric machine for each qualified acceleration event (by reducing the dynamic acceleration limit to a lower value or zero). When the accelerator pedal is no longer at WOP, the dynamic acceleration limiting module 218 resets and is ready to detect the next qualified acceleration event (e.g., the next corner exit).

In some examples, the dynamic acceleration limiting module 218 does not allow use of the dynamic acceleration limit mode again until a change in vehicle speed (e.g., from a maximum vehicle speed during the qualified acceleration event) is greater than a predetermined change in vehicle speed. For example, the predetermined change in vehicle speed may be greater than or equal to 20 km/h, although other values can be used.

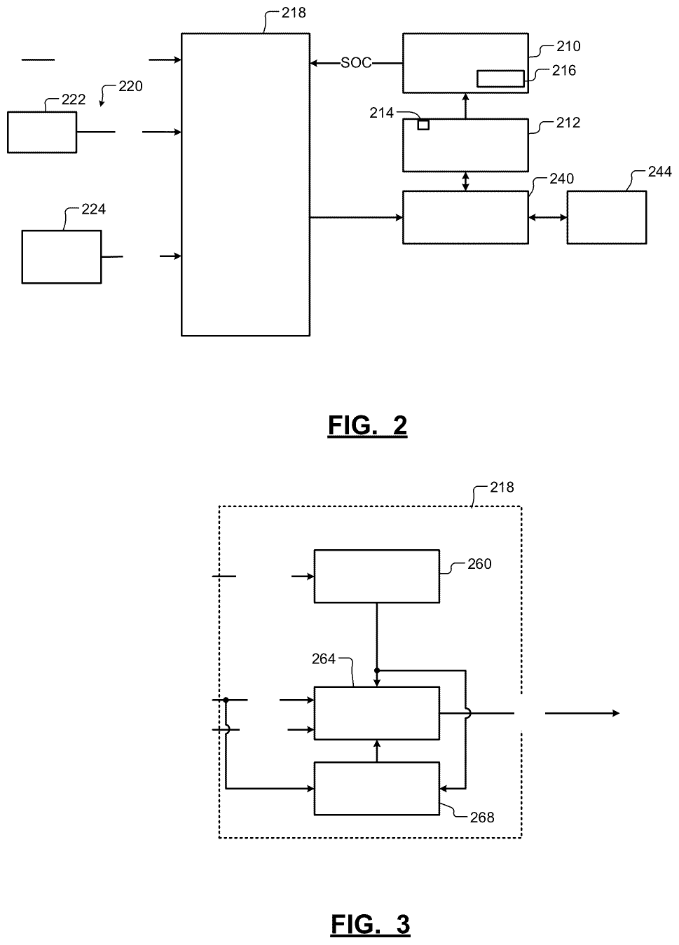

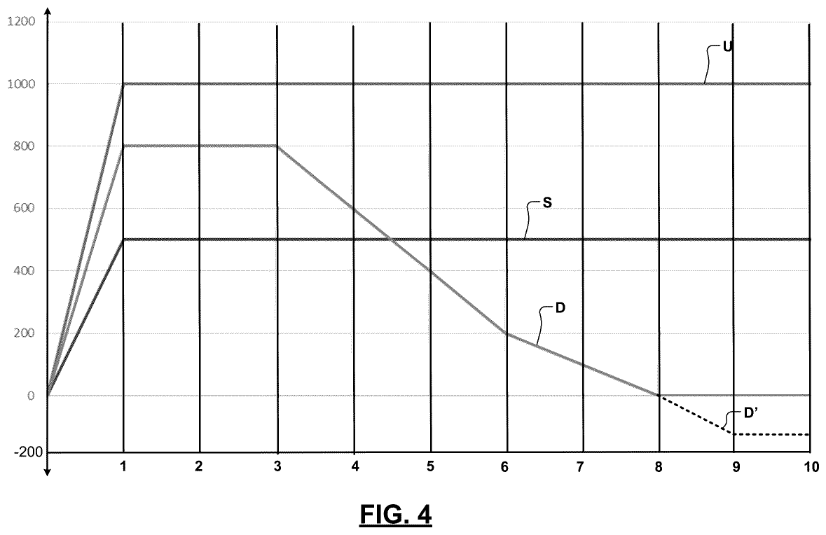

Referring now to FIG. 3, an example of the dynamic acceleration limiting module 218 includes a comparing module 260 configured to compare a current acceleration request to a predetermined acceleration threshold. The comparing module 260 outputs a first state when the accelerator request (e.g., pedal position) is less than or equal to the predetermined threshold (e.g., predetermined pedal position) and a second state (e.g., WOP) when the acceleration request is greater than the predetermined acceleration threshold.

An SOC usage module 268 receives an output of the comparing module 260 and the current SOC. The SOC usage module 268 determines SOC consumption during the qualified acceleration event (in other words, while the qualified acceleration event is enabled). In some examples, the SOC consumption is determined in response to a difference between the SOC at the start of the acceleration event and the current SOC. An acceleration limit determining module 264 receives an output of the comparing module 260, the vehicle speed, the SOC, and/or the SOC consumed since the beginning of the acceleration event. The acceleration limit determining module 264 outputs an acceleration value (e.g., torque/power) limited by the dynamic acceleration limit to the power inverter module 240 during the acceleration event.

The dynamic acceleration limit according to the present disclosure dynamically limits output of the electric machine during a qualified acceleration event. For example, the dynamic acceleration limit may correspond to a torque limit that varies as a function of time (or based on other parameters described herein) and is less than unlimited torque limit during at least a portion of the acceleration event. The dynamic acceleration limit is in contrast to a static torque limit that corresponds to a simple fixed torque limit that does not vary with time and/or other inputs. In other words, the dynamic acceleration limit is dynamic because it varies as a function of time during the qualified acceleration event. For example, the dynamic acceleration limit may initially be high (e.g., up to the unlimited torque) and then the acceleration limit ramps downwardly to zero during the acceleration event (assuming the hybrid is still in a qualified acceleration event) based on speed, current SOC, and/or SOC consumed.

The dynamic acceleration limit is applied for qualified acceleration events. In some examples, the qualified acceleration events occur during hard acceleration that occurs during corner exits on track (or during other performance driving) when the accelerator request is greater than the threshold (e.g., the pedal is depressed beyond the accelerator pedal threshold and is maintained above the accelerator pedal threshold). The dynamic acceleration limit reduces SOC consumption that is expended on corner exits and subsequent straight track portions.

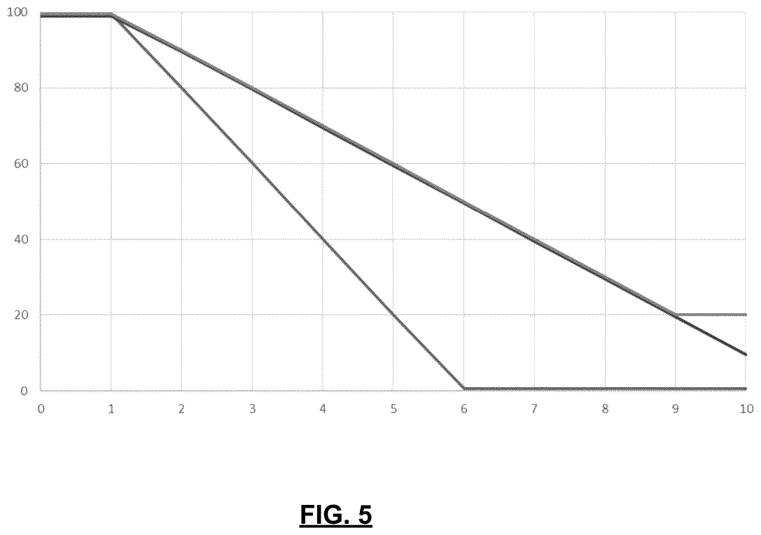

Referring now to FIGS. 4 to 6, an example using axle torque is shown. However, acceleration or other parameters related to torque or power can be used. In FIG. 4, axle torque is shown as a function of time for wide open pedal (WOP) tip in. Some EVs use an unlimited torque limit U. When the unlimited torque limit U is used, torque can increase to a maximum value of the motor/battery combination. However, the SOC of the battery falls relatively quickly and/or excessive heating of the motor and/or battery may occur. Other EVs use a static torque limit S. When the static torque limit Uis used, torque can increase to a static value (less than the maximum torque of the motor/battery combination). The static torque limit is a fixed value that does not change with time.

EVs according to the present disclosure use a dynamic torque limit D. When the dynamic torque limit D is used, the torque varies dynamically during the qualified acceleration event. For example, the torque initially increases to a predetermined maximum value for a predetermined period after wide open pedal (WOP) tip in and then decreases after the predetermined period (assuming that the acceleration event continues).

In some examples, the dynamic torque limit D may transition to a negative torque value for hybrid vehicles. Regeneration of the battery occurs when negative torque is produced (e.g., the electric machine acts as a generator to supply current to the battery to charge the battery). The negative torque is less noticeable at higher speeds near the end of the straight since the internal combustion engine can still provide torque to increase speed. In some examples, the dynamic acceleration limit monotonically decreases as a function of time after reaching a maximum torque during the qualified acceleration event.

Referring now to FIG. 5, the SOC for EVs using the unlimited torque limit U, the dynamic torque limit D, and the static limited torque limit S are shown during successive track laps. The SOC of the EV using the unlimited torque limit U falls faster and hits 0% SOC faster than the static limited torque limit S and the dynamic torque limit D. Because the rate of energy consumption is reduced during dynamic acceleration limiting, the SOC depletes more slowly which extends the amount of time that electric propulsion is available to the driver during performance driving.

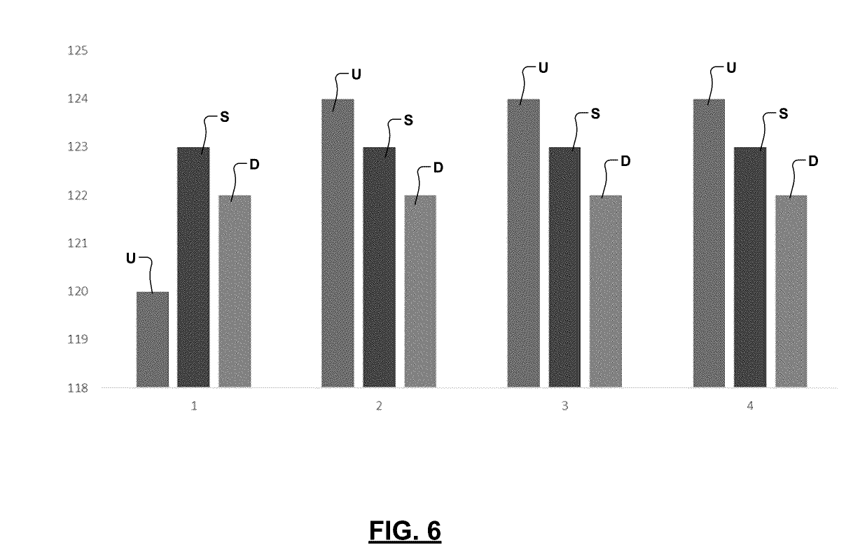

Referring now to FIG. 6, successive lap times are shown using the unlimited torque limit U, the dynamic torque limit D, and the static limited torque limit S. Initially, the EV using the unlimited torque limit U has the fastest lap. However, the lap times of EV using the unlimited torque limit U fade significantly after the first lap and are less consistent. The EV using the dynamic torque limit D provides faster lap times after the initial lap and is more consistent than the unlimited torque limit U. Further, the EV using the dynamic torque limit D is able to maintain lap times for subsequent laps.

Referring now to FIG. 7, a method for operating the dynamic acceleration limiting module is shown. At 410, the method determines whether a mode selected by the driver corresponds to a dynamic acceleration limiting mode or a performance mode with dynamic acceleration limiting. Non-limiting examples of performance modes include track or sport modes.

When 410 is true, the method determines whether a qualified acceleration event is occurring at 414 (e.g., the acceleration request is greater than a threshold) to enable dynamic acceleration limiting. If 414 is true, the method enables dynamic acceleration limiting and starts calculating consumed SOC during the qualified acceleration event. At 420, the method determines whether the consumed SOC is less than a second threshold and/or a measured temperature of the electric machine(s) and/or battery are less than corresponding thresholds TH3. If 420 is true, the method continues at 420.

At 422, the method sets the dynamic acceleration limit in response to vehicle speed, SOC and consumed SOC. In some examples, the dynamic acceleration limit dynamically controls torque output by the electric machine during the acceleration event.

When either 410, 414, of 420 are false, the method resets consumed SOC at 424 (since the qualified acceleration event is over) so that the consumed SOC is reset prior to the next qualified acceleration event.

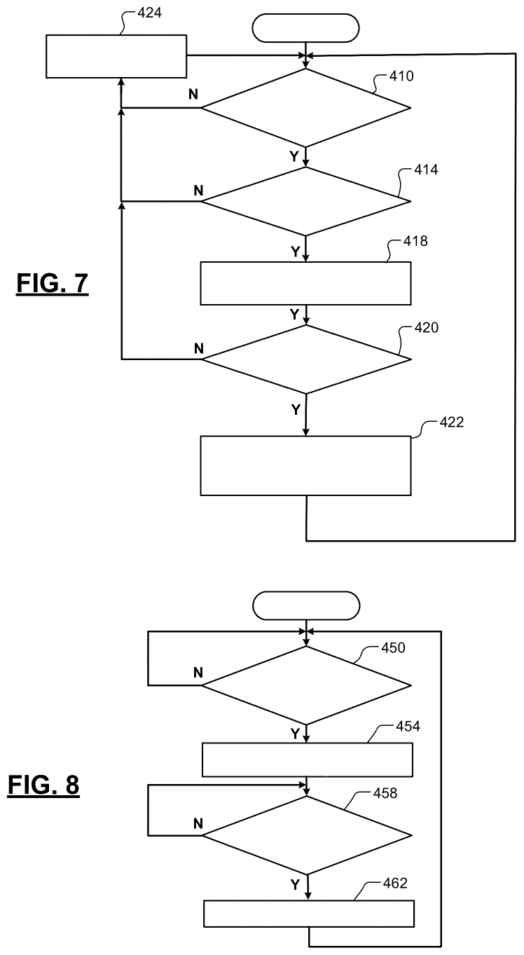

Referring now to FIG. 8, in some examples, after the acceleration event ends, the dynamic acceleration limit is temporarily disabled until a change in vehicle speed (e.g., maximum vehicle speed during the prior acceleration event) is greater than a predetermined threshold. This function can be used to enable increased acceleration using the dynamic acceleration limit mode once during each straight track section. For example, a driver may attempt to enable increased acceleration using the dynamic acceleration limit mode more than once during a straight track section by releasing the accelerator pedal below the threshold and then depressing the acceleration pedal above the threshold again during the same straight track section. When the vehicle enters a corner, the vehicle speed will decrease by a predetermined value (e.g., greater than 20 km/h) due to braking and then the dynamic acceleration limit mode is enabled and can be used again.

At 450, the method determines whether the acceleration event ended. At 454, the method temporarily disables dynamic acceleration limiting. At 458, the method determines whether the change in vehicle speed is greater than a predetermined threshold TH4. If 458 is true, the method enables dynamic acceleration limiting at 462.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python@.

What is claimed is:

1. An acceleration control system for a vehicle, comprising:
a battery pack;
an electric machine;
an inverter configured to output power from the battery pack to the electric machine;
an accelerator module configured to generate an acceleration request;
a selector configured to selectively enable a dynamic acceleration limiting mode; and
a dynamic acceleration limiting module configured to identify, when the dynamic acceleration limiting mode is enabled, a qualified acceleration event in response to the accelerator request greater than an acceleration threshold and to output a dynamic acceleration limit for the electric machine to the inverter during the qualified acceleration event.

2. The acceleration control system of claim 1, wherein the accelerator module comprises an acceleration pedal and the acceleration threshold corresponds to a pedal position.

3. The acceleration control system of claim 1, wherein the acceleration request corresponds to at least one of power request and a torque request.

4. The acceleration control system of claim 1, wherein at least one of:
the selector enables selection of a performance mode of the vehicle and the dynamic acceleration limiting mode is enabled in response to the performance mode being active, and
the selector enables dynamic acceleration limiting independently of selection of a performance mode of the vehicle.

5. The acceleration control system of claim 1, wherein:
the vehicle comprises a hybrid vehicle, and
the dynamic acceleration limit varies as a function of time during the qualified acceleration event.

6. The acceleration control system of claim 5, wherein the dynamic acceleration limit monotonically decreases as a function of time after reaching a peak value during the qualified acceleration event.

7. The acceleration control system of claim 5, wherein the dynamic acceleration limiting module decreases the dynamic acceleration limit to a negative value during the qualified acceleration event.

8. The acceleration control system of claim 1, further comprising:
a battery monitoring module configured to determine a state of charge of the battery pack,
wherein the dynamic acceleration limiting module is configured to receive the state of charge of the battery pack and to calculate consumed state of charge during the qualified acceleration event.

9. The acceleration control system of claim 8, wherein the dynamic acceleration limiting module is configured to adjust the dynamic acceleration limit in response to the consumed state of charge.

10. The acceleration control system of claim 1, wherein the dynamic acceleration limiting module is configured to adjust the dynamic acceleration limit in response to vehicle speed.

11. The acceleration control system of claim 1, further comprising:
a battery monitoring module configured to determine a state of charge of the battery pack,
wherein the dynamic acceleration limiting module is configured to:
receive the state of charge of the battery pack and to calculate consumed state of charge during the qualified acceleration event, and
adjust the dynamic acceleration limit in response to the consumed state of charge and vehicle speed.

12. The acceleration control system of claim 1, wherein the vehicle comprises a battery electric vehicle.

13. The acceleration control system of claim 1, wherein:
the dynamic acceleration limiting module is configured to disable the dynamic acceleration limiting mode after the qualified acceleration event until a change in vehicle speed is greater than a predetermined speed change threshold, and
the change in vehicle speed is based on a difference between a maximum vehicle speed during the qualified acceleration event and a current vehicle speed.

14. A method for controlling acceleration of an electric machine of a vehicle, comprising:
determining whether a dynamic acceleration limiting mode of the vehicle is active;
when the dynamic acceleration limiting mode is active, selectively identifying a qualified acceleration event by comparing an acceleration request to a predetermined threshold; and
when the dynamic acceleration limiting mode is active, setting an acceleration limit of the electric machine to a dynamic acceleration limit during the qualified acceleration event.

15. The method of claim 14, further comprising at least one of:
enabling selection of a performance mode of the vehicle, wherein the dynamic acceleration limiting mode is active in response to the performance mode being selected, and
enabling the dynamic acceleration limiting mode independently of selection of a performance mode of the vehicle.

16. The method of claim 14, wherein the vehicle comprises one of a hybrid vehicle and a battery electric vehicle.

17. The method of claim 14, further comprising:
varying the dynamic acceleration limit as a function of time during the qualified acceleration event, and
monotonically decreasing the dynamic acceleration limit as a function of time after reaching a peak value during the qualified acceleration event.

18. The method of claim 17, further comprising decreasing the dynamic acceleration limit to a negative value during the qualified acceleration event.

19. The method of claim 14, further comprising:
calculating a state of charge of a battery pack;
calculating consumed state of charge during the qualified acceleration event; and
adjusting the dynamic acceleration limit in response to the consumed state of charge and vehicle speed.

20. An acceleration control system for a hybrid vehicle, comprising:
a powertrain including an internal combustion engine and a transmission propelling at least one wheel of the hybrid vehicle;
a battery pack;
a battery monitoring module configured to determine a state of charge of the battery pack;
an electric machine propelling at least one wheel of the hybrid vehicle;
an inverter configured to output power from the battery pack to the electric machine;
an accelerator pedal;
a selector configured to selectively activate a dynamic acceleration limiting mode; and
a dynamic acceleration limiting module configured to identify, when the dynamic acceleration limiting mode is active, a qualified acceleration event in response to a position of the accelerator pedal and to determine a dynamic acceleration limit for the electric machine during the qualified acceleration event,
wherein the dynamic acceleration limit varies as a function of time during the qualified acceleration event,
wherein the dynamic acceleration limiting module is configured to receive the state of charge of the battery pack and to calculate consumed state of charge during the qualified acceleration event,
wherein the dynamic acceleration limiting module is configured to adjust the dynamic acceleration limit in response to the consumed state of charge and vehicle speed.
